(19) United States
(12) Patent Application Publication
(10) Pub. No.: US 2011/0047553 A1
(43) Pub. Date: Feb. 24, 2011

(54) APPARATUS AND METHOD FOR INPUT/OUTPUT PROCESSING OF MULTI-THREAD

(75) Inventors: Eun-Ji LIM, Daejeon (KR); Kang-Ho Kim, Daejeon (KR); Soo-Young Kim, Daejeon (KR); Sung-In Jung, Daejeon (KR)

Correspondence Address: AMPACC Law Group, PLLC, 6100 219th Street SW, Suite 580, Mountlake Terrace, WA, 98043, US

(73) Assignee: Electronics and Telecommunications Research Institute, Daejeon (KR)

(21) Appl. No.: 12/816,298

(22) Filed: Jun. 15, 2010

(30) Foreign Application Priority Data
Aug. 18, 2009 (KR) 10-2009-0076168

(51) Int. Cl. G06F 9/50

(52) U.S. Cl. 718/104

(57) ABSTRACT

Provided sets a limit of execution threads which can be simultaneously processes in an input/output system and compares the number of threads which are being currently executed with the limit of execution threads at the time of requesting an input/output event from a thread and manages a job of processing the input/output event in accordance with the comparison result. The apparatus for asynchronous input/output processing of a multi-thread according to the present invention restricts the number of threads which are processed in the asynchronous input/output system as many as the limit of execution threads to prevent deterioration of performance caused due to context switching overhead of the thread and efficiently manage the thread.

### RELATED APPLICATIONS

The present application claims priority to Korean Patent Application Serial Number 10-2009-0076168, filed on Aug. 18, 2009, the entirety of which is hereby incorporated by reference.

### BACKGROUND OF THE INVENTION

1. Field of the Invention

The present invention relates to an apparatus and a method for asynchronous input/output processing of a multi-thread, and more particularly, to an apparatus and a method for efficient thread management by optimizing performance when the multi-thread performs asynchronous input/output processing in a computer operating system.

2. Description of the Related Art

In general, a structure of an asynchronous input/output system in a Linux operating system is performed by an input/output context and a plurality of input/output control blocks in the asynchronous input/output system.

When the thread requests an asynchronous input/output job according to a request from a user, the input/output control block is generated and connected to the input/output context according to the request from the user. At this time, the generated input/output control block requests the input/output job to the input/output context and the input/output context performs a substantial input/output job according to the request of the input/output control block. Herein, the input/output control block is deleted when the input/output job is completed by the input/output processor.

Meanwhile, the input/output processor stores an input/output event which is a result of the input/output job in a ring buffer. At this time, the ring buffer exists to correspond to the input/output context one by one and the input/output processor stores the input/output event in the ring buffer corresponding to the corresponding input/output context.

Thereafter, the thread takes the input/output event from the ring buffer and processes the input/output result.

However, in the case of the thread processing method, a thread control is not considered when the multi-thread performs the asynchronous input/output. For example, when 100 threads request the input/output event, if enough numbers of events are provided in the ring buffer, all of the 100 threads take the input/output events and simultaneously processes the input/output events. By this configuration, since too many threads are simultaneously executed, context switching overhead of the thread is increased, thereby deteriorating the performance of the system.

As such, it is important to determine the proper number of threads and control execution of the thread at the time of using the multi-thread and a technique to enable the multi-thread to efficiently process the asynchronous input/output is required in the asynchronous input/output system.

### SUMMARY OF THE INVENTION

In order to solve the above-mentioned problem, an object of the present invention is to provide an apparatus and a method for asynchronous input/output processing of a multi-thread that can improve the performance of a system by efficiently controlling a thread when the multi-thread processes asynchronous input/output at the same time.

In order to achieve the above-mentioned object, an apparatus for asynchronous input/output processing of a multi-thread includes an input/output processor that performs the input/output job requested by each thread when input/output jobs are requested by threads; a ring buffer that stores an input/output event generated in accordance with the result of processing the input/output job of the input/output processor; and a main controller that sets a limit of execution threads, which can be simultaneously processed in a corresponding input/output system, compares the number of threads which are being currently executed with the limit of execution threads when the input/output event is requested by the thread, and manages a job of processing the input/output event stored in the ring buffer in accordance with the comparison result.

The main controller sets the limit of execution threads as many as the number of processors installed in the computer system.

The main controller counts the number of threads which are being executed in the corresponding input/output system.

The main controller increases the number of execution threads at the time of allocating the input/output event to the thread and decreases the number of execution threads when processing the input/output event allocated to the thread is completed.

The main controller deactivates the thread and adds it to a standby thread list when the number of execution thread is equal to or more than the limit of execution threads.

The main controller activates the thread registered in the standby thread list and allocates the input/output event to the corresponding thread when the number of threads which are being currently executed is less than the limit of execution threads.

The main controller verifies whether or not the input/output event is provided in the ring buffer when a thread requests the input/output event. The main controller adds the corresponding thread to the standby thread list if the input/output event is not provided in the ring buffer. Thereafter, the main controller activates the thread in the standby thread list and allocates the input/output event to the corresponding thread when one or more input/output event is registered in the ring buffer.

Meanwhile, the apparatus for asynchronous input/output processing of a multi-thread further includes a storage storing input/output context that includes the limit of execution threads and the number of execution threads.

Further, the apparatus for asynchronous input/output processing of a multi-thread further includes an input/output control block that is generated in correspondence with the request for the input/output job of each thread when the input/output job is requested by the thread and records processing information of the corresponding input/output job while the input/output job is performed by the input/output processor, and the input/output control block is removed when the corresponding input/output job is completed by the input/output processor.

Meanwhile, in order to achieve the above-mentioned object, a method for asynchronous input/output processing of a multi-thread according to another embodiment of the present invention includes setting a limit of execution threads which can be simultaneously processed in an asynchronous input/output system; performing an input/output job in accordance with a request from at least one thread and storing an input/output event generated in accordance with the result of performing the job in a ring buffer; comparing the number of threads which are being currently executed with the limit of execution threads set at the setting step when the input/output event is requested by the thread; and extracting the input/output event from the ring buffer and allocating the extracted input/output event to the corresponding thread in accordance with a comparison result at the comparing step.

At the setting step, the limit of execution threads is set to a value as many as processors installed in the corresponding computer system.

The method for asynchronous input/output processing of a multi-thread further includes counting the number of threads which are being executed in the corresponding input/output system.

The number of execution threads is increased at the time of allocating the input/output event to the thread and the number of execution threads is decreased when processing of the input/output event allocated to the thread is completed.

The method for asynchronous input/output processing of a multi-thread further includes, in accordance with the comparison result at the comparing step, when the number of threads which are being currently executed is equal to or more than the limit of execution threads, deactivating the thread and adding the corresponding thread to the standby thread list.

When the number of threads which are being currently executed is less than the limit of execution threads, a thread in the standby thread list is activated and an input/output event is allocated to the thread.

The method for asynchronous input/output processing of a multi-thread further includes, before the allocating step, verifying whether or not the input/output event is provided in the ring buffer.

In accordance with the verification result at the verifying step, deactivating a thread requesting the input/output event and adding the corresponding thread to the standby thread list when the input/output event is not provided in the ring buffer.

When the input/output event is registered in the ring buffer after adding the thread to the standby thread list, the thread is activated and the input/output event is allocated to the corresponding thread.

According to an embodiment of the present invention, a multi-thread can efficiently perform asynchronous input/output in an asynchronous input/output system so as to improve the performance.

Further, the present invention has an advantage of conveniently providing a program having optimized performance even though a user does not perform additional management and control of the thread for improvement in the performance when the user develops program in which multi-thread uses the asynchronous input/output.

In addition, the method for asynchronous input/output processing of a multi-thread according to the embodiment of the present invention can prevent deterioration in the performance due to context switching overhead of the thread by restricting the number of threads simultaneously processed in the asynchronous input/output system to as many as the limit of execution threads.

Further, it is possible to maximize the efficiency of an input/output job by utilizing all processors installed in the computer system.

### BRIEF DESCRIPTION OF THE DRAWINGS

FIG. 1 is a diagram illustrating a configuration of an asynchronous input/output system according to an embodiment of the present invention;

FIG. 2 is a diagram illustrating a configuration of an asynchronous input/output system according to another embodiment of the present invention;

FIG. 3 is an exemplary diagram referenced for describing an operation of an asynchronous input/output system according to an embodiment of the present invention; and

FIGS. 4 to 6 are flowcharts illustrating an operational flow of a method for input/output processing in an asynchronous input/output system according to an embodiment of the present invention.

### DETAILED DESCRIPTION OF THE PREFERRED EMBODIMENTS

Hereinafter, embodiments of the present invention will be described in detail with reference to the accompanying drawings.

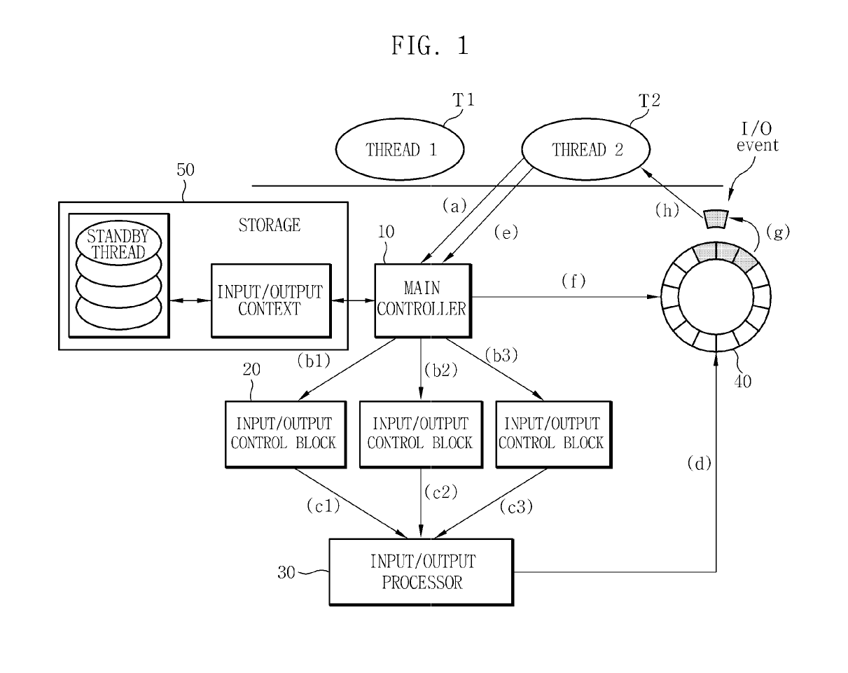

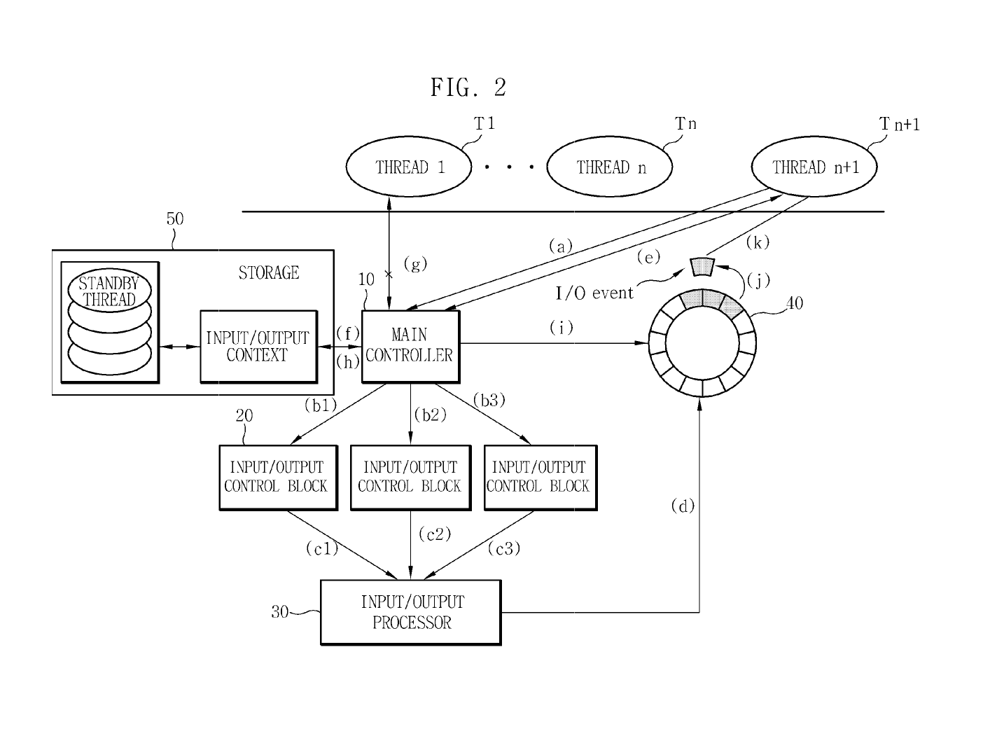

FIGS. 1 and 2 are diagrams referenced for describing a configuration of an apparatus for asynchronous input/output processing of a multi-thread according to an embodiment of the present invention.

The apparatus for asynchronous input/output processing of a multi-thread according to the embodiment of the present invention restricts the number of threads which can be simultaneously processed in the corresponding input/output system by setting the limit of execution threads in an asynchronous input/output system. At this time, the limit of execution threads is set to a value as many as the number of processors which are installed in the corresponding computer system in order to maximally utilize a processor installed in the corresponding computer system.

First, FIG. 1 is a diagram reference for describing an operation when the number of threads which are being executed is less than the limit of execution threads in the asynchronous input/output system. At this time, in FIG. 1, there is illustrated an embodiment when an input/output event is requested by a thread 2 T2 in a state where a thread 1 T1 is already being executed.

Referring to FIG. 1, the apparatus of asynchronous input/output processing of a multi-thread according to the embodiment of the present invention includes a main controller 10, an input/output control block 20, an input/output processor 30, a ring buffer 40, and a storage 50.

The main controller 10 sets the limit of execution threads which can be simultaneously processed in the corresponding input/output system. At this time, the limit of execution threads is set to a value as many as the number of processors which are installed in the corresponding system. The limit of execution threads, which is set by the main controller 10, is stored in an input/output context. Thereafter, the main controller 10 counts the number of threads which are being executed while the input/output event is processed by the thread in the corresponding input/output system.

Likewise, the number of execution threads which is counted by the main controller 10 is stored in the input/output context.

The storage 50 stores the input/output context which includes the limit of execution threads and the number of execution threads. The storage 50 further stores standby thread list which includes deactivated thread.

When an input/output job is requested from the thread 2 T2 to the main controller 10 as shown in (a), the main controller 10 generates the input/output control block 20 in correspondence with the input/output job requested by the thread 2 T2. Herein, when input/output jobs are requested from a plurality of threads, the input/output control block 20 are generated in correspondence with the input/output jobs requested by the threads, respectively.

At this time, the main controller 10 transfers a signal requesting the input/output job to the input/output control block 20 as illustrated in (b1) to (b3) and each input/output control block 20 outputs a signal requesting the input/output job to the input/output processor 30 as illustrated in (c1) to (c3).

Further, information on the corresponding input/output job is stored in the input/output control block 20. For example, a user buffer address, a file descriptor, the kind of input/output job, etc. are stored in the input/output control block 20. Therefore, the input/output control block 20 requests the input/output job to the input/output processor 30 based on processing information of the stored input/output job until the corresponding input/output job is completed.

Meanwhile, the input/output control block 20 is removed by the main controller 10 when the corresponding input/output job is completed by the input/output processor 30.

The input/output processor 30 performs the input/output job according to the request for the input/output job from each input/output control block 20. The input/output processor 30 stores the input/output event generated according to the result of the input/output job in the ring buffer 40 as illustrated in (d) after the input/output job is completed.

Meanwhile, the input/output processor 30 stores the input/output event in the ring buffer 40 and thereafter, outputs a predetermined signal to the main controller 10. At this time, the main controller 10 verifies whether or not the registered thread is provided in the standby thread list from the signal from the input/output processor 30. If the registered thread is provided in the standby thread list, the main controller 10 activates a thread having priority among the threads in the standby thread list and thereafter, allocates the registered input/output event to the ring buffer 40. This corresponds to only a case where the number of threads which are being currently executed is less than the limit of execution threads.

Meanwhile, when the input/output event is requested by the thread 2 T2, the main controller 10 extracts the input/output event from the ring buffer 40 and allocates the input/output event to the thread 2 T2.

At this time, the main controller 10 verifies whether or not the number of execution threads is less than the limit of execution threads by comparing the limit of execution threads with the number of threads which are being currently executed before allocating the corresponding input/output event to the thread 2 T2. The main controller 10 extracts the input/output event from the ring buffer 40 and allocates the extracted input/output event to the thread 2 T2 only when the number of execution threads is less than the limit of execution threads as illustrated in FIG. 1.

Meanwhile, when the input/output event is requested by the thread 2 T2, the main controller 10 verifies whether or not the input/output event is provided in the ring buffer 40. If the input/output event is provided in the ring buffer 40, the main controller 10 allocates the input/output event to the thread 2 T2 by extracting the input/output event registered in the ring buffer 40 as illustrated in (g) and (h). Accordingly, the thread 2 T2 processes the input/output event extracted from the ring buffer 40.

In contrast, when the input/output event is requested by the thread 2 T2, the main controller 10 switches the thread 2 T2 into a sleep mode and deactivates the thread 2 T2 and thereafter, adds the deactivated thread 2 T2 to a standby thread list if the input/output event is not provided in the ring buffer 40. When an input/output event is registered in the ring buffer 40 by the input/output processor 30 afterwards, the main controller 10 re-activates the thread 2 T2 registered in the standby thread list and thereafter, allocates the input/output event registered in the ring buffer 40 to the thread 2 T2. Therefore, the thread 2 T2 processes the input/output event extracted from the ring buffer 40.

The thread that is allocated with the input/output event called from the ring buffer 40 transmits a predetermined signal to the main controller 10. The main controller 10 increases the number of threads which are being currently executed based on the signal transmitted from the thread. For example, when the current thread 1 T1 is already executed, the number of execution threads becomes ‘2’ based on the signal transmitted from the thread 2 T2 at that time. Of course, the threads T1 and T2 which are being executed transmit a predetermined signal indicating termination of the job to the main controller 10 when processing the input/output event is completed. At this time, the main controller 10 decreases the number of threads which are being executed based on the signal transmitted from the threads T1 and T2.

Therefore, the main controller 10 counts the number of execution threads and compares the number of execution threads with the limit of execution threads whenever the plurality of threads are executed to prevent the number of execution threads from being more than the predetermined limit of execution threads.

Meanwhile, FIG. 2 is a diagram reference for describing an operation when the number of threads which are being executed is more than the limit of execution threads in the asynchronous input/output system according to the embodiment of the present invention. At this time, in FIG. 2, there is illustrated an embodiment when the limit of execution threads is n.

In other words, the limit of execution threads is determined by the number of processors installed in the corresponding asynchronous input/output system. Therefore, since the number of processors installed in the system, the limit of execution threads is set to n.

Referring to FIG. 2, when a request for an input/output job is inputted from a thread n+1 Tₙ₊₁ to the main controller 10 as shown in (a) in a state when n threads are already executed, the main controller 10 generates the input/output control block 20 in correspondence with the request for the input/output job from the thread n+1 Tₙ₊₁. At this time, the main controller 10 transfers an input/output requesting signal to the corresponding input/output control block 20 and each input/output control block 20 outputs a signal requesting the input/output job to the input/output processor 30.

The input/output processor 30 performs the input/output job according to the request for the input/output job from the input/output control block 20. At this time, the input/output control block 20 is removed when the input/output job is completed by the input/output processor 30. The input/output processor 30 stores the input/output event generated according to the result of the input/output job in the ring buffer 40 after the input/output job is completed.

Meanwhile, when the input/output event is requested by the thread, the main controller 10 compares the number of threads which are being currently executed with the limit of execution threads. When the number of execution threads already reaches the limit of execution threads, the main controller 10 deactivates the threads that requests the input/output event and adds the corresponding thread to the standby thread list.

In FIG. 2, since the number of execution threads already reaches the limit of execution threads, the main controller 10 switches the thread n+1 Tₙ₊₁ that requests the input/output event into the sleep mode and deactivates the thread and thereafter, adds the thread n+1 Tₙ₊₁ to the standby thread list.

At this time, the main controller 10 verifies whether or not the number of execution threads becomes less than the limit of execution threads by comparing the limit of execution threads with the number of threads which are being currently executed in real time. If the number of execution threads becomes less than the limit of execution threads, the main controller 10 activates the deactivated thread in the standby thread list, and extracts the corresponding input/output event from the ring buffer 40 and allocates the extracted input/output event to the activated thread.

Herein, the main controller 10 preferentially activates a thread having higher priority among the threads in the standby thread list at the time of activating the threads in the standby thread list.

As illustrated in (g) of FIG. 2, when the thread 1 T1 completes the job, the thread T1 outputs a predetermined signal indicating that processing the input/output event is completed to the main controller 10. The main controller 10 decreases the number of execution threads by 1 on the basis of the signal from the thread 1 T1. At this time, since the number of execution threads is less than the limit of execution threads, the main controller 10 activates the thread having higher priority among the threads in the standby thread list. In the embodiment of FIG. 2, there is illustrated an example in which the thread n+1 Tₙ₊₁ is activated.

Herein, the main controller 10 verifies whether or not the input/output event is provided in the ring buffer 40 before (or after) activating the thread in the standby thread list. When the input/output event is not provided in the ring buffer 40, the main controller 10 maintains the thread in the standby thread list until the input/output event is provided in the ring buffer 40.

Meanwhile, when the input/output event is provided in the ring buffer 40, the main controller 40 activates the thread n+1 Tₙ₊₁ and thereafter, extracts the input/output event from the ring buffer 40 and allocates the extracted input/output event to the thread n+1 Tₙ₊₁. Therefore, the thread n+1 Tₙ₊₁ processes the allocated input/output event. Likewise, when the thread n+1 Tₙ₊₁ is allocated with the input/output event, the thread n+1 Tₙ₊₁ outputs a predetermined signal to the main controller 10 to increase the number of execution threads by 1.

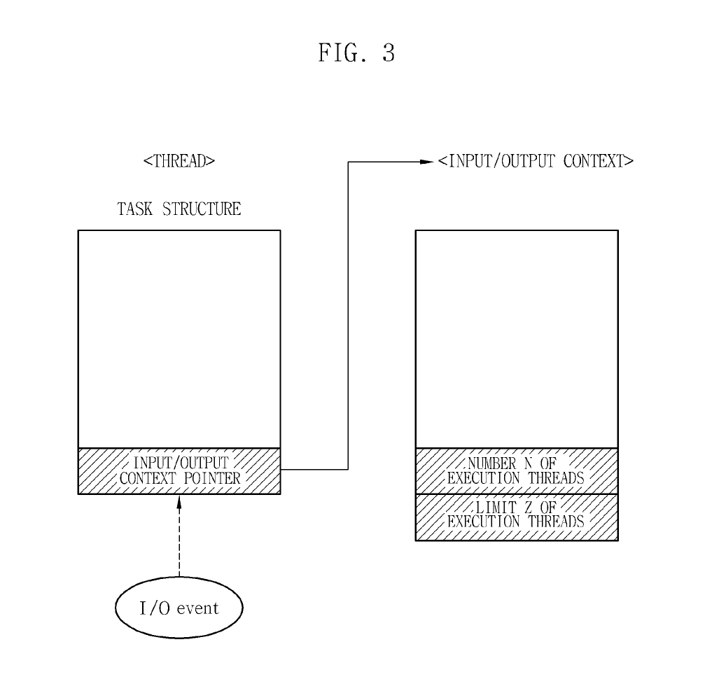

FIG. 3 illustrates structures of a thread and an input/output context according to an embodiment of the present invention. In particular, FIG. 3 illustrates an operation performed between the thread and the input/output context in the apparatus for asynchronous input/output processing of a multi-thread at the time of processing the input/output event.

Referring to FIG. 3, in the case of the thread, an input/output context pointer indicating the input/output context is provided in a task structure which is a data structure showing the thread and the process in a kernel. Meanwhile, various meta information which should be maintained for each user process are stored in the input/output context.

If the input/output event from the ring buffer 40 is allocated to the thread, the corresponding thread transmits a predetermined signal to the input/output context so as to connect the input/output context pointer of the task structure to the input/output context.

The input/output context manages the limit Z of execution threads in the corresponding input/output system. Further, the input/output context manages the number N of execution threads through the input/output context pointer.

For example, when the input/output context pointer of the execution thread is connected to the input/output context, the input/output context increases the number of execution threads. Meanwhile, when the job of the execution thread is completed, the input/output context pointer of the corresponding thread and the input/output context are disconnected from each other. Accordingly, the input/output context decreases the number of execution threads.

At this time, the input/output context compares the number N of execution threads with the limit Z of execution threads and manages the number N to prevent the number of execution threads which are simultaneously executed from being more than the limit Z of execution threads.

An operation relating to a method for asynchronous input/output processing of a multi-thread according to an embodiment of the present invention will be described below.

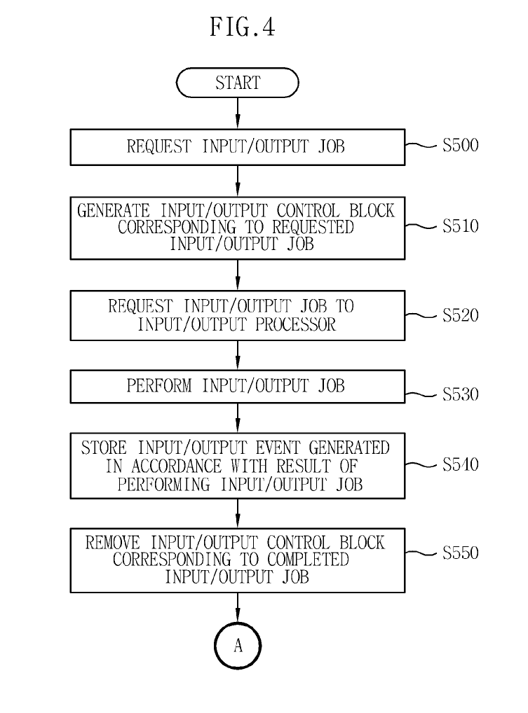

FIGS. 4 to 6 are flowcharts illustrating an operational flow of a method for asynchronous input/output processing in a multi-thread according to an embodiment of the present invention.

First, FIG. 4 illustrates a procedure of performing an input/output job in an input/output system. Referring to FIG. 4, when an input/output job is requested by a thread (S500), a main controller 10 generates an input/output control block 20 corresponding to the request for the input/output job from the thread (S510).

The input/output control block 20 transmits a signal of requesting the input/output job to an input/output processor 30 according to the request from the thread (S520) and the input/output processor 30 performs the input/output job according to a control signal from the input/output control block 20 (S530). At this time, the input/output control block 20 is removed when the input/output job is completed by the input/output processor 30.

Meanwhile, the input/output processor 30 stores the input/output event generated according to the result of the input/output job in a ring buffer 40 after the input/output job is completed (S540).

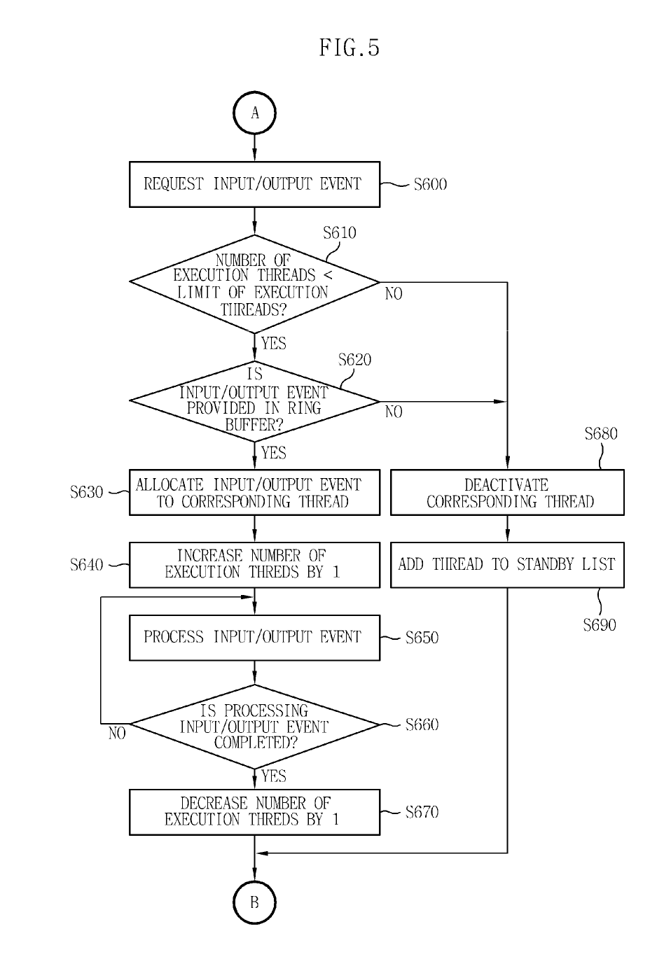

Steps ‘S500’ to ‘S550’ of FIG. 4 are repetitively performed whenever the input/output jobs are requested from a plurality of threads. Thereafter, the main controller 10 returns to step ‘A’ of FIG. 5 and performs the following procedure.

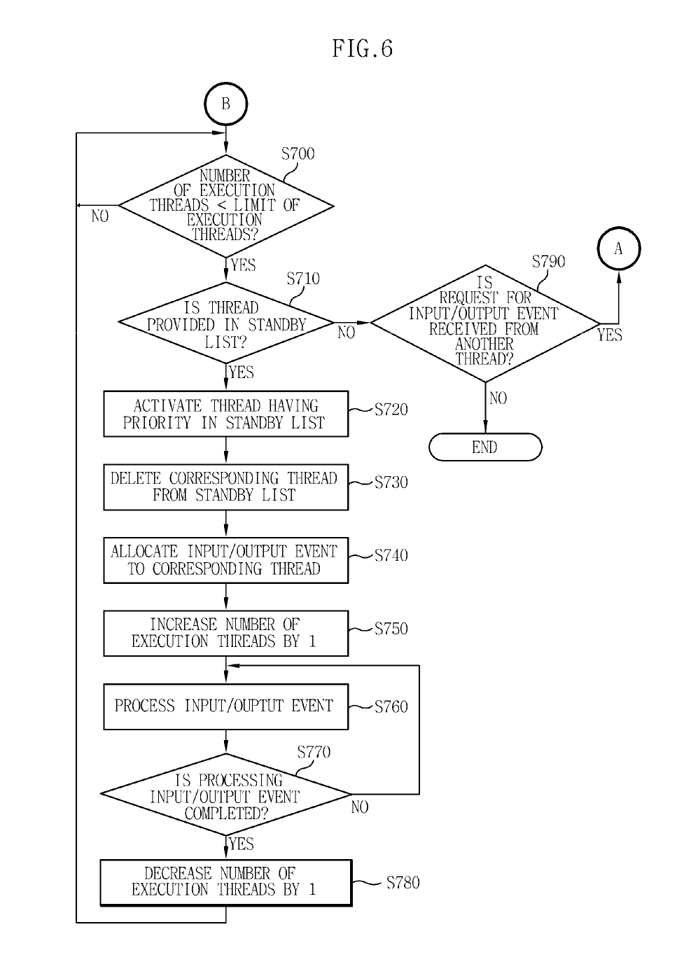

Meanwhile, FIGS. 5 and 6 illustrate a procedure in which the thread processes an input/output event. Referring to FIG. 5, when the input/output event is requested by the thread (S600), the main controller 10 verifies whether or not the registered input/output event is provided in the ring buffer 40 (S610).

If the input/output event is not provided in the ring buffer 40, the main controller 10 switches the corresponding thread into a sleep mode and deactivates the thread (S650) and adds the thread to a standby thread list (S660).

In contrast, when the input/output event is requested by the thread, the main controller 10 verifies whether or not the number of threads which are being currently executed is less than a set limit of execution threads (S620) if the input/output event is provided in the ring buffer 40. At this time, if the number of threads which are being currently executed is less than the set limit of execution threads, the main controller 10 extracts the input/output event registered in the ring buffer 40 and allocates the extracted input/output event to the corresponding thread (S630). Meanwhile, if the number of threads which are being currently executed is equal to or more than the set limit of execution threads, the main controller 10 switches the corresponding thread into the sleep mode and deactivates the thread (S650) and adds the thread to the standby thread list (S660).

Thereafter, if the number of threads which are being currently executed is less than the set limit of execution threads, the main controller 10 activates the thread in the standby thread list, and extracts the input/output event registered in the ring buffer 40 and allocates the extracted input/output event to the corresponding thread (S630).

Accordingly, the thread processes the input/output event allocated by the main controller 10 (S640).

Although not illustrated in the embodiment of FIG. 5, after the thread processes the input/output event, the thread reports the processing result to the main controller 10. At this time, the main controller 10 decreases the number of execution threads as many as the number of threads which complete processing of the input/output event.

When an operation of processing the input/output event by the thread is completed, the main controller 10 performs operations after ‘B’ of FIG. 6.

Referring to FIG. 6, when the input/output job is completed by the input/output processor 30 and thus, the input/output event is stored in the ring buffer 40 or the operation of processing the input/output event from the corresponding thread is completed, the main controller 10 compares a previously registered limit of execution threads with the number of threads which are being currently executed (S700).

At this time, if the number of threads which are being currently executed is less than the set limit of execution threads, the main controller 10 verifies whether or not the registered thread is provided in the standby thread list (S710).

If the registered thread is provided in the standby thread list, the main controller 10 activates a thread having priority among the threads in the standby thread list (S720) and thereafter, deletes the corresponding thread from the standby thread list (S730). Herein, although not illustrated in FIG. 6, the main controller 10 activates the thread in the standby thread list and thereafter, increases the number of threads which are being executed as many as the number of activated threads.

Further, the main controller 10 calls the input/output event stored in the ring buffer 40 and allocates the corresponding input/output event to the activated thread (S740) and the corresponding thread processes the input/output event allocated by the main controller 10 (S750). Of course, as described above, when processing of the input/output event is completed by the thread, the main controller 10 decreases the number of threads which are being executed.

As such, the main controller 10 manages the threads in the system by verifying the number of execution threads in real time.

In contrast, when the number of threads which are being executed is equal to or more than the set limit of execution threads at step ‘S700’, the job is terminated and is on standby until the number of execution threads is less than the limit of execution threads as long as there is no additional event request. Thereafter, when the number of execution threads is less than the limit of execution threads, steps after step ‘S700’ are performed.

When the number of execution threads is less than the limit of execution threads, the process is on standby until the input/output event is requested by another thread if the thread registered in the standby thread list is not provided at step ‘S710 ’ (S760). Thereafter, when the input/output event is requested by another thread, steps after ‘A’ of FIG. 5 are performed.

As described above, the apparatus and method for asynchronous input/output processing of a multi-thread according to the embodiment of the present invention are not limited to the configuration and method of the embodiments described as above, but the embodiments may be configured by selectively combining all the embodiments or some of the embodiments so that various modifications can be made.

What is claimed is:

1. An apparatus for asynchronous input/output processing of a multi-thread, comprising:
an input/output processor that performs the input/output job requested by each thread when input/output jobs are requested by threads;
a ring buffer that stores an input/output event generated in accordance with the result of processing the input/output job of the input/output processor; and
a main controller that sets a limit of execution threads, which can be simultaneously processed in a corresponding input/output system, compares the number of threads which are being currently executed with the limit of execution threads when the input/output event is requested by the thread, and manages a job of processing the input/output event stored in the ring buffer in accordance with the comparison result.

2. The apparatus for asynchronous input/output processing of a multi-thread according to claim 1, wherein the main controller sets the limit of execution threads as many as the number of processors installed in the corresponding computer system.

3. The apparatus for asynchronous input/output processing of a multi-thread according to claim 1, wherein the main controller counts the number of threads which are being executed in the corresponding input/output system.

4. The apparatus for asynchronous input/output processing of a multi-thread according to claim 3, wherein the main controller increases the number of execution threads at the time of allocating the input/output event to the thread and decreases the number of execution threads when processing the input/output event allocated to the thread is completed.

5. The apparatus for asynchronous input/output processing of a multi-thread according to claim 1, wherein the main controller deactivates the thread and adds the corresponding thread to a standby thread list when the number of execution thread is equal to or more than the limit of execution threads.

6. The apparatus for asynchronous input/output processing of a multi-thread according to claim 5, wherein the main controller activates the corresponding thread registerd in the standby thread list and allocates the input/output event to the thread when the number of threads which are being currently executed is less than the limit of execution threads.

7. The apparatus for asynchronous input/output processing of a multi-thread according to claim 1, wherein the main controller verifies whether or not the input/output event is provided in the ring buffer when the input/output event is requested by the thread and adds the corresponding thread to the standby thread list if the input/output event is not provided in the ring buffer.

8. The apparatus for asynchronous input/output processing of a multi-thread according to claim 7, wherein the main controller activates the corresponding thread in the standby thread list and allocates the input/output event to the thread when one or more input/output event is registered in the ring buffer.

9. The apparatus for asynchronous input/output processing of a multi-thread according to claim 1, further comprising:
a storage storing an input/output context that includes the limit of execution threads and the number of execution threads.

10. The apparatus for asynchronous input/output processing of a multi-thread according to claim 1, further comprising:
an input/output control block that is generated in correspondence with the request for the input/output job of each thread when the input/output job is requested by the thread and records processing information of the corresponding input/output job while the input/output job is performed by the input/output processor.

11. The apparatus for asynchronous input/output processing of a multi-thread according to claim 10, wherein the input/output control block is removed when the corresponding input/output job is completed by the input/output processor.

12. A method for asynchronous input/output processing of a multi-thread, comprising:
setting a limit of execution threads which can be simultaneously processed in an asynchronous input/output system;
performing an input/output job in accordance with a request from at least one thread and storing an input/output event generated in accordance with the result of performing the job in a ring buffer;
comparing the number of threads which are being currently executed with the limit of execution threads set at the setting step when the input/output event is requested by the thread; and
extracting the input/output event from the ring buffer in accordance with a comparison result at the comparing step and allocating the extracted input/output event to the corresponding thread.

13. The method for asynchronous input/output processing of a multi-thread according to claim 12, further comprising:
deactivating the thread and adding the corresponding thread to the standby thread list when the number of threads which are being currently executed is equal to or more than the limit of execution threads in accordance with the comparison result at the comparing step.

14. The method for asynchronous input/output processing of a multi-thread according to claim 13, wherein when the number of threads which are being currently executed is less than the limit of execution threads, the corresponding thread registered in the standby thread list is activated and the input/output event is allocated to the thread.

15. The method for asynchronous input/output processing of a multi-thread according to claim 12, wherein in the setting step, the limit of execution threads is set to a value as many as processors installed in the corresponding computer system.

16. The method for asynchronous input/output processing of a multi-thread according to claim 12, further comprising:
counting the number of threads which are being executed in the corresponding input/output system.

17. The method for asynchronous input/output processing of a multi-thread according to claim 16, wherein the counting step increases the number of execution threads at the time of allocating the input/output event to the thread and decreases the number of execution threads when processing of the input/output event allocated to the thread is completed.

18. The method for asynchronous input/output processing of a multi-thread according to claim 12, further comprising: verifying whether or not the input/output event is provided in the ring buffer before the allocating step.

19. The method for asynchronous input/output processing of a multi-thread according to claim 18, further comprising:
deactivating a thread requesting the input/output event and adding the corresponding thread to the standby thread list when the input/output event is not provided in the ring buffer in accordance with the verification result at the verifying step.

20. The method for asynchronous input/output processing of a multi-thread according to claim 19, wherein the corresponding thread in the standby thread list is activated and the input/output event is allocated to the thread when the input/output event is registered in the ring buffer.
